(19) United States
(12) Patent Application Publication
(10) Pub. No.: US 2008/0007654 A1
(43) Pub. Date: Jan. 10, 2008

(54) System, method and medium reproducing multimedia content

(75) Inventors: Hee-seob Ryu, Yongin-si (KR); Min-kyu Park, Yongin-si (KR); Sang-goog Lee, Yongin-si (KR); Jong-ho Lea, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/655,823

(22) Filed: Jan. 22, 2007

(30) Foreign Application Priority Data
Jul. 5, 2006 (KR) 10-2006-0063153

(51) Int. Cl. H04N 5/445

(52) U.S. Cl. 348/564

(57) ABSTRACT

Provided is a system, method and medium reproducing multimedia content in which the display position of an image and one of a plurality of audio channels are corrected with respect to a region selected by a user when multimedia content is reproduced. The system reproducing multimedia content includes a display unit to display an image through a display region divided into a plurality of subregions, an audio output unit to divide audio corresponding to the displayed image into a plurality of channels and to output the audio, a calculation unit to calculate correction values to correct a display position of the image and to correct the audio channels corresponding to a subregion selected by a user, and a signal processing unit to correct the display position and the audio channels based on the calculated correction values.

### CROSS-REFERENCE TO RELATED APPLICATIONS

This application claims priority from Korean Patent Application No. 10-2006-0063153 filed on Jul. 5, 2006 in the Korean Intellectual Property Office, the disclosure of which is incorporated herein by reference in its entirety.

### BACKGROUND

1. Field

One or more embodiments of the present invention relate to a system, method and medium reproducing multimedia content, and more particularly, to a system, method and medium reproducing multimedia content in which the display position of an image and one of a plurality of audio channels are corrected with respect to a region selected by a user when multimedia content is reproduced.

2. Description of the Related Art

Recently, the number of people who want to watch theater-quality multimedia content at home is on the rise. In response to this trend, research related to stereo sound technology that will allow users to enjoy three-dimensional, realistic and high-quality sound is active. Also, systems for reproducing multimedia content that use stereo sound technology, such as home theater systems, are increasingly being used.

As is generally known, human ears can sense the direction and position of a sound source based on the difference between the strength of sounds, and the relative time difference for the sounds to reach the ears. Stereo sound technology and surround sound technology rely on this characteristic of the human ear to give listeners the same audio perspective, in reproducing multimedia content, that they would get at the original sound source, using two or more audio channels, each of which terminates in one or more loudspeakers.

However, conventional systems for reproducing multimedia content merely reproduce the original multimedia content as originally produced, and are focused on only providing optimum sound in a predetermined room location. Accordingly, when multimedia content is reproduced, conventional multimedia content reproduction systems do not provide images and sound with respect to an image region or room location of user interest.

### SUMMARY

One or more embodiments of the present invention provides a system, method and medium of reproducing multimedia content in which when multimedia content is reproduced, the display position of an image and one of a plurality of audio channels are corrected with respect to a region selected by a user.

Additional aspects and/or advantages of the invention will be set forth in part in the description that follows and, in part, will be apparent from the description, or may be learned by practice of the invention.

According to an aspect of the present invention, there is provided a system for reproducing multimedia content, the system including a display unit to display an image through a display region divided into a plurality of subregions, an audio output unit to divide audio corresponding to the displayed image into a plurality of channels and to output the audio, a calculation unit to calculate correction values to correct a display position of the image and to correct audio channels corresponding to a subregion selected by a user; and a signal processing unit to correct the display position and the audio channels based on the calculated correction values.

According to an aspect of the present invention, there is provided a method reproducing multimedia content, the method including displaying an image through a display region divided into a plurality of subregions, dividing audio corresponding to the displayed image into a plurality of channels and outputting the audio, calculating correction values to correct a display position of the image, and to correct the audio channels corresponding to a subregion selected by a user, and correcting the display position and the audio channels based on the calculated correction values.

According to an aspect of the present invention, there is provided at least one medium comprising computer readable code to control at least one processing element to implement a method reproducing multimedia content including displaying an image through a display region divided into a plurality of subregions, dividing audio corresponding to the displayed image into a plurality of channels and outputting the audio, calculating correction values to correct a display position of the image, and to correct the audio channels corresponding to a subregion selected by a user, and correcting the display position and the audio channels based on the calculated correction values.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a system reproducing multimedia content, according to an embodiment of the present invention;

FIG. 2 illustrates a direct pointing device, according to an embodiment of the present invention;

FIGS. 3A through 3C illustrate a process of detecting screen coordinates using the direct pointing device illustrated in FIG. 2, according to an embodiment of the present invention;

FIG. 4 illustrates a system reproducing multimedia content illustrated in FIG. 1, according to an embodiment of the present invention;

FIG. 5 illustrates a divided display region, according to an embodiment of the present invention;

FIG. 6 illustrates a mapping table, according to an embodiment of the present invention;

FIG. 7 illustrates a method of calculating a correction value, according to an embodiment of the present invention;

FIGS. 8A through 8C illustrate images displayed through a display region of the system reproducing multimedia content illustrated in FIG. 4, according to an embodiment of the present invention; and

FIG. 9 illustrates a method of reproducing multimedia content, according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

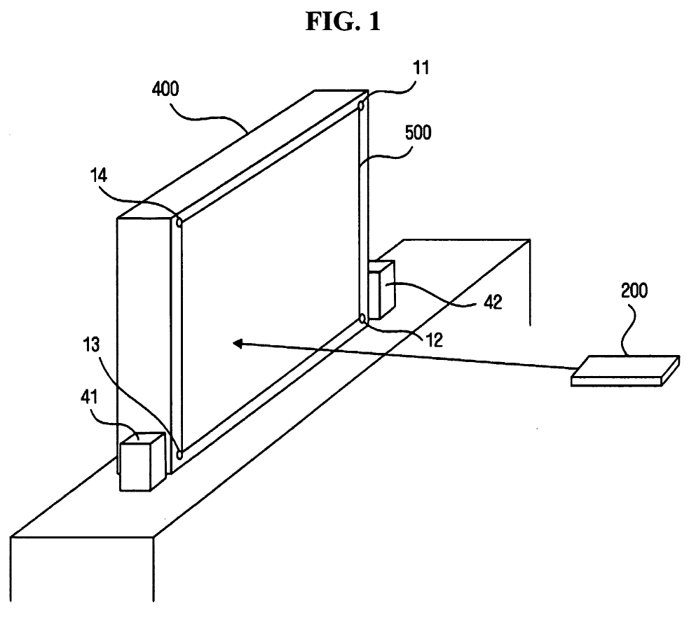

FIG. 1 illustrates a system reproducing multimedia content, according to an embodiment of the present invention. The system reproducing multimedia contents may include a pointing device 200 and a system reproducing multimedia content 400, for example.

The pointing device 200 may be used to point to a region of interest in an image reproduced through the system reproducing multimedia content 400. An indirect pointing device, such as a mouse, or a direct pointing device, may be used as the pointing device 200. A direct pointing device will be used as an example of the pointing device 200 in one or more embodiments of the present invention, however other pointing devices may also be used.

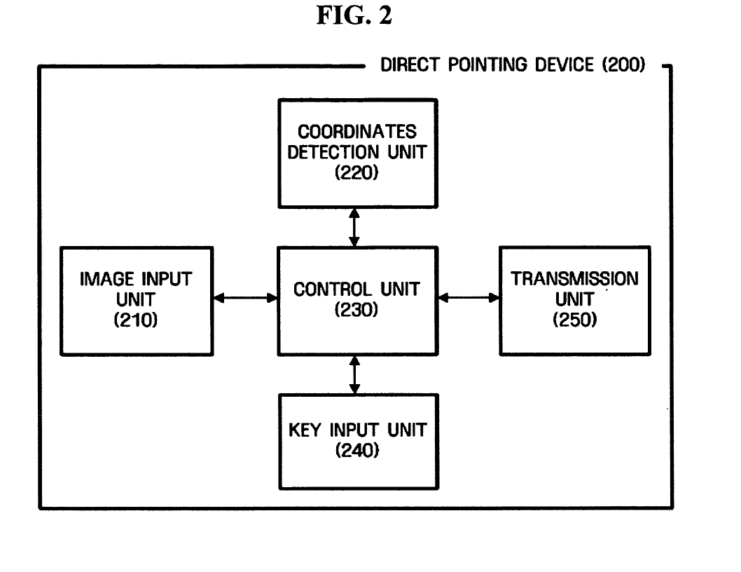

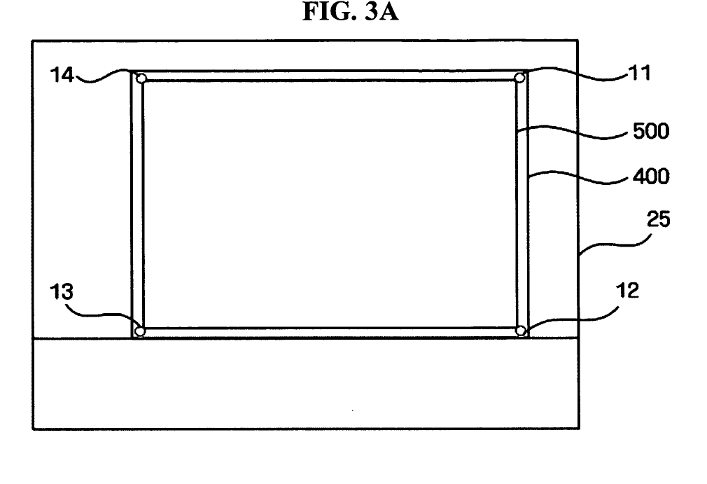

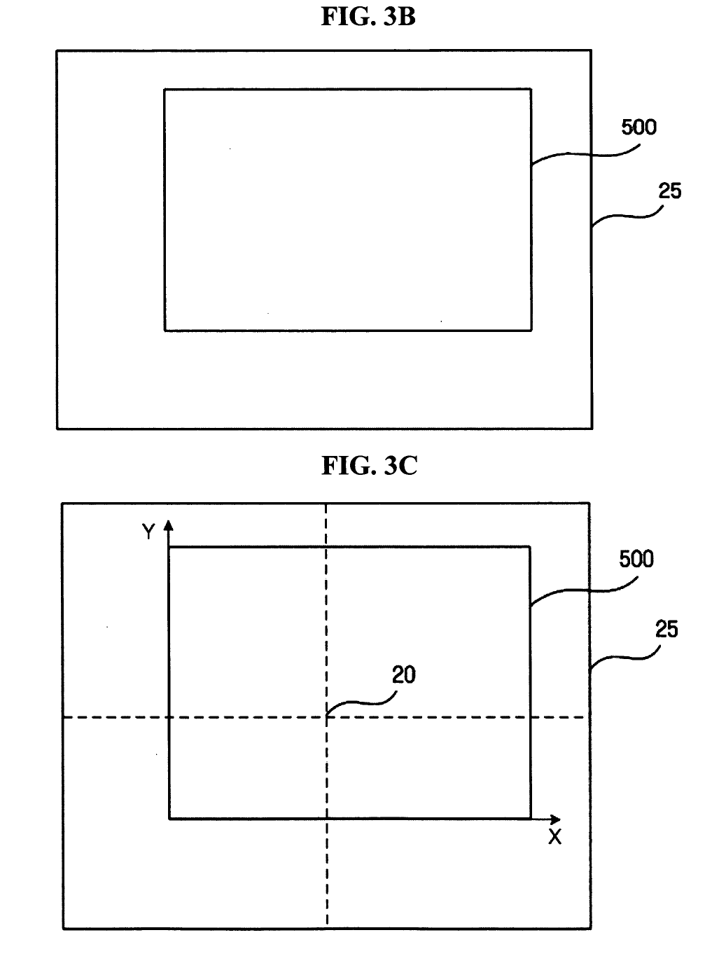

The direct pointing device 200 may transmit a user's command to the system 400. Also, the direct pointing device 200 may detect a display region 500 and the coordinates of a pointed-to spot in the display region 500. FIG. 2 illustrates the direct pointing device 200 according to an embodiment of the present invention, and FIGS. 3A through 3C illustrate screens input to the direct pointing device 200 of FIG. 2.

First, referring to FIG. 2, the direct pointing device 200 may include a key input unit 240, an image input unit 210, a coordinates detection unit 220, a control unit 230 and a transmission unit 250, for example.

The key input unit 240 may have a plurality of function keys for controlling operations of the system reproducing multimedia content 400. For example, a power key (not shown), a selection key (not shown) and a plurality of numeric keys (not shown) may be disposed on the key input unit 240. When applied by the user, keys disposed on the key input unit 240 generate predetermined key signals. A key signal generated in the key input unit 240 may be provided to the control unit 230, as will be explained in more detail herein below.

The control unit 230 may link each element in the direct pointing device 200 and may control each element according to a user's command. For example, the control unit 230 may generate a command code corresponding to a key signal provided by the key input unit 240. Then, this command code may be provided to the transmission unit 250, which will be explained below.

The image input unit 210 may receive an image taken in the direction pointed to by the direct pointing device 200. This image input unit 210 may be formed with an image sensor such as a camera, for example.

The coordinates detection unit 220 may detect the display region 500 of the system reproducing multimedia content 400 from image data input by the image input unit 210. The coordinates detection unit 220 may detect the display region 500 in a variety of ways.

As an example, the coordinates detection unit 220 may detect the display region 500 using differences in luminance values in the image data input through the image input unit 210, since the display region 500 in which an image is displayed is brighter than surrounding areas, for example. Accordingly, if the edges of a section having higher luminance values are detected in the image data input through the image input unit 210, the display region 500 of the system reproducing multimedia content 400 may be detected.

Also, the display region 500 of the system reproducing multimedia content 400 may be detected, for example, using a mark that can be easily recognized by a camera. More specifically, a light emitting device, for example, an infrared light emitting diode (LED) 11-14, may be disposed on each corner of the display region 500 of the system 400. Then, if a region having a higher luminance, that is, an infrared LED, is detected in the image data 25 input through the image input unit 210, the display region 500 of the system 400 may be detected because the position of the infrared LED is known to be that of a corner. For example, if an image 25 input through the image input unit 210 is as shown in FIG. 3A, the coordinates detection unit 220 may detect the display region 500 of the system 400 as illustrated in FIG. 3B.

After detecting the display region 500 of the system reproducing multimedia content 400 in this manner, the coordinates detection unit 220 may detect the position of a spot currently pointed to by the user in the detected display region 500. That is, the coordinates detection unit 220 may calculate the coordinates of the pointed-to spot in the detected display region 500. The coordinates detection unit 220 may detect the coordinates of the pointed-to spot using a variety of methods.

As an example, referring to FIG. 3C, if the user points to the center 20 of the image 25 input through the image input unit 210 using the direct pointing device 200, the coordinates detection unit 220 may first detect the center 20 of the image 25 input through the image input unit 210. Then, the coordinates detection unit 220 may detect the position of the detected center 20 in the already detected display region 500, and thus may detect the coordinates of the pointed-to spot with reference to the detected display region 500. The coordinates detection unit 220 may provide the detected coordinates to the transmission unit 250.

The transmission unit 250 may modulate the command code provided by the control unit 230 and the data detected in the coordinates detection unit 220, that is, the coordinates of the pointed-to spot, into a predetermined wireless signal, for example, an infrared signal, and transmits the modulated signal to the system reproducing multimedia content 400.

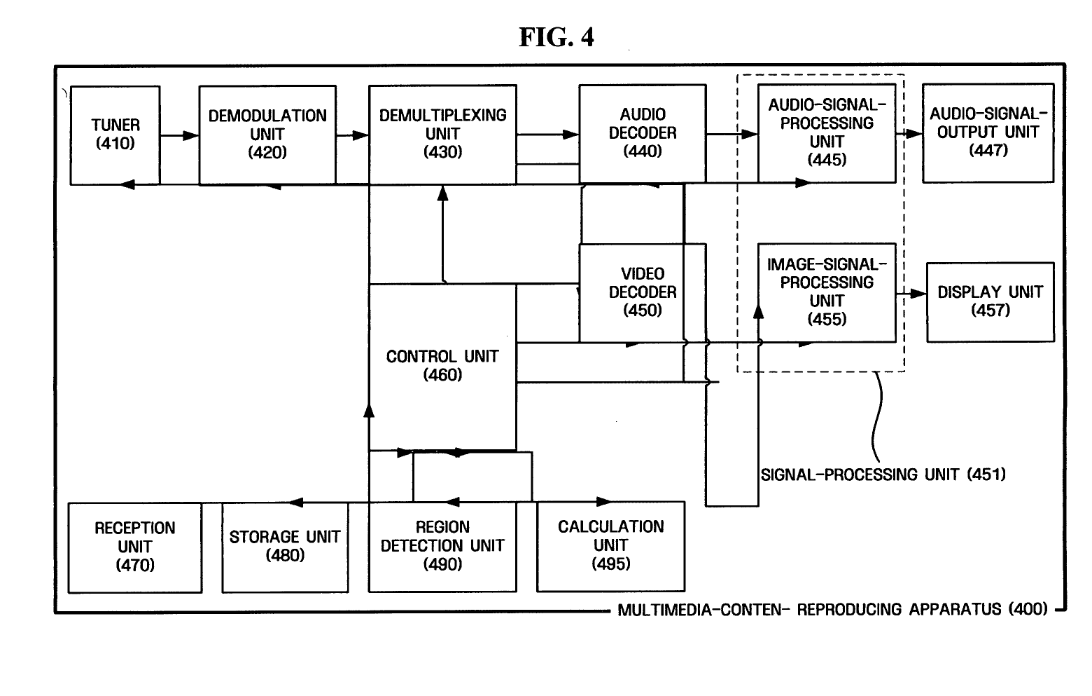

Meanwhile, the system 400, according to an embodiment of the present invention, may receive the coordinates of the spot pointed to by the user from the direct pointing device 200, and correct the display position of the image and one of a plurality of audio channels with respect to the region that includes the pointed-to spot. The system 400 may be formed as a digital system, which is a system or apparatus having at least one digital circuit for processing digital data. Examples of digital apparatuses include a mobile phone, a computer, a monitor, a digital camera, a digital home appliance, a digital phone, a digital video recorder, a personal digital assistant (PDA), and a digital TV. An embodiment in which the system 400 is implemented as a digital TV will now be explained with reference to FIGS. 4 through 8C.

FIG. 4 illustrates a system for reproducing multimedia content illustrated in FIG. 1, according to an embodiment of the present invention. The system 400 illustrated in FIG. 4 may include a tuner 410, a demodulation unit 420, a demultiplexing unit 430, a video decoder 450, a display unit 457, an audio decoder 440, signal processing unit 451, a audio output unit 447, a storage unit 480, a reception unit 470, a region detection unit 490, a calculation unit 495, and a control unit 460, for example.

The tuner 410 may perform tuning to a reception band of a channel selected by a user, transform the received signal wave into an intermediate frequency signal and provide the signal to the demodulation unit 420.

The demodulation unit 420 may demodulate the digital signal provided by the tuner 410 and provide data in an MPEG-2 transport stream format, for example, to the demultiplexing unit 430.

The demultiplexing unit 430 may separate compressed audio data and image data from the input MPEG-2 transport stream and provide the audio data and image data to the audio decoder 440 and the video decoder 450, respectively.

The video decoder 450 may decode the input image data. The decoded image data may be provided to the image signal processing unit 455, which will be explained in more detail herein below, and then, may be displayed through the display unit 457.

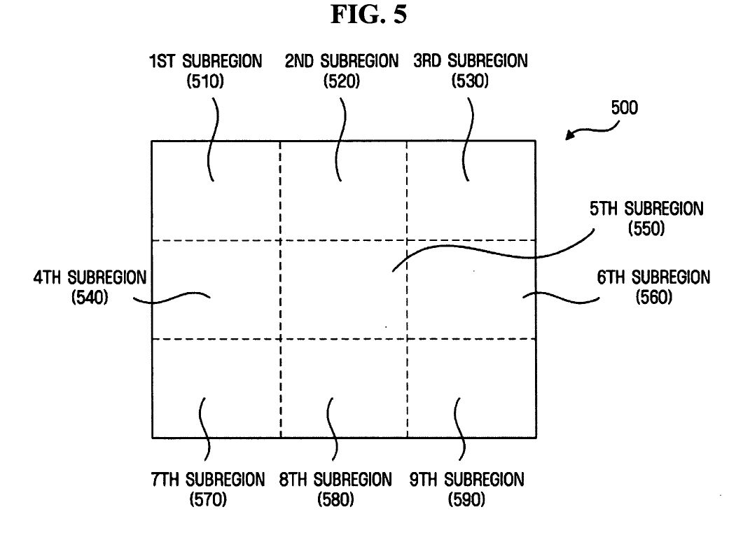

The display unit 457 may display the signal processed image through the image signal processing unit 455, which will be explained in greater detail herein below. The display unit 457 may include a display region 500 in which the image signal is displayed and the display region 500 may be divided into a plurality of subregions, each subregion being formed with one or more pixels. For example, the display region 500 may be divided into a plurality of subregions as illustrated in FIG. 5, where the display region 500 is divided into identical subregions. However, the display region 500 may also be divided into nonidentical subregions.

The audio decoder 440 may decode the input audio data. The decoded audio data may be provided to the audio signal processing unit 445 and processed in a predetermined manner, and then, may be output through the audio output unit 447.

The audio output unit 447 may separate audio corresponding to the image displayed through the display unit 457, into a plurality of channels and output the audio. To achieve this, the audio output unit 447 may be implemented using a plurality of speakers 41 and 42. The plurality of speakers 41 and 42 may be disposed at predefined positions relative to the system reproducing multimedia content 400.

The control unit 460 may link elements in the system 400 and may manage the elements.

The storage unit 480 may store an algorithm required for correcting the scale of an image and the audio channel based on a subregion selected by the user when multimedia content is reproduced. Also, the storage unit 480 may store a mapping table 600 including identification information on a plurality of subregions, coordinate value information corresponding to each subregion, and central point coordinates information of each subregion, for example. The storage unit 480 may be implemented by at least one of a non-volatile memory, such as a read only memory (ROM), a programmable ROM (PROM), an erasable programmable ROM (EPROM), an electrically erasable programmable ROM (EEPRON), a flash memory, or a volatile memory, such as a random access memory (RAM), and a storage medium, such as a hard disk drive (HDD), although the storage unit 480 is not limited to these examples.

The reception unit 470 may receive a remote control signal and coordinates of a pointed-to spot transmitted by the direct pointing device 200. The received coordinates of the pointed-to spot may be provided to the region detection unit 490, which will be explained in greater detail herein below.

The region detection unit 490 may detect a subregion including the coordinates of the pointed-to spot, by referring to the mapping table 600 stored in the storage unit 480, for example. Information on the detected subregion may be provided to the calculation unit 495, which will be explained in greater detail herein below.

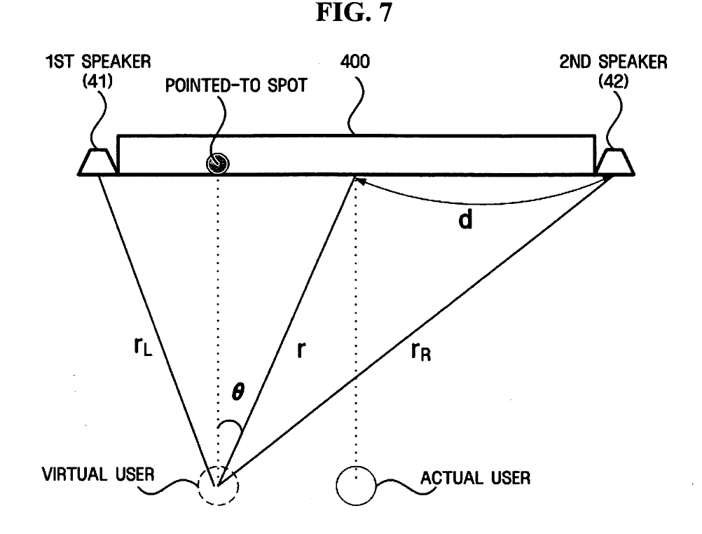

The calculation unit 495 may calculate correction values to correct the scale of an image, and the audio channel, based on the detected subregion information. First, the calculation unit 495 may calculate a correction value for correcting the scale of the image. More specifically, the calculation unit 495 may calculate the distance between the center of the detected subregion and the center of the display region 500, for example. The calculated distance value may be provided to the image signal processing unit 455, which will be explained in greater detail herein below. Also, the calculation unit 495 may calculate a correction value for correcting the audio channel output through the audio output unit 447. More specifically, the calculation unit 495 may calculate the gains output from, and the phase difference between, channels output from the audio output unit 447. FIG. 7 will now be referred to for a more detailed explanation of the gain calculation.

FIG. 7 illustrates a method of calculating a correction value, according to an embodiment of the present invention, and in particular, illustrates a method of calculating the gain output of each of channel and the phase difference between the channels output through the audio output unit 447.

First, the calculation unit 495 may position a virtual user at a position facing a pointed-to spot as illustrated in FIG. 7. Then, the calculation unit 495 may calculate the angle (θ) between the line segment connecting the pointed-to spot and the virtual user, and the line segment connecting the virtual user and the central point of the display region 500. Here, the angle (θ) between the two line segments may be calculated through a database formed based on prior experiments. More specifically, the angle (θ) may be measured while changing the pointed-to spot along the X-axis of the display region 500, and the results of the measuring may be stored in the storage unit 480. Then, by searching the stored database, the angle (θ) between the two line segments may also be calculated.

After the angle (θ) between the two line segments has been calculated, the calculation unit 495 may calculate the distance (r_{L}) between the virtual user and the first speaker 41 and the distance (r_{R}) between the virtual user and the second speaker 42, based on the calculated angle (θ), the distance information (2d) between the first speaker 41 disposed to the left of the display region 500 and the second speaker 41 disposed to the right of the display region 500, and the distance information (r) from the central point to the virtual user, for example.

More specifically, assuming that the angle between the two line segments is θ, the distance information between the first speaker 41 and the second speaker 42 is 2d and the distance from the central point to the virtual user is r, the distance r_{L} between the virtual user and the first speaker 41 may be expressed as in equation 1 below, and the distance r_{R} between the virtual user and the second speaker 42 may be expressed as in equation 2 below:

$$\begin{matrix}Equation 1 \text{:} & \\ {r}_{L} = \sqrt{{r}^{2} + {d}^{2} - 2 rd sin θ} & \\ Equation 2 \text{:} & \\ {r}_{R} = \sqrt{{r}^{2} + {d}^{2} + 2 rd sin θ} \\ sonnie \\ & \end{matrix}$$

In equations 1 and 2, the distance information (2d) between the first speaker 41 and the second speaker 42 may be specified in advance as an ordinary value. Also, the distance (r) between the central point and the virtual user may also be specified in advance as an ordinary value. For example, the distance (r) between the central point and the virtual user may be specified as 3m, which is an ordinary distance.

If the distance (r_{L}) between the virtual user and the first speaker 41 and the distance (r_{R}) between the virtual user and the second speaker 42 are calculated using equations 1 and 2, the calculation unit 495 may calculate the gains (g) output from, and the phase difference (Δ) between, channels output through respective speakers, based on the calculated distance values (r_{L} and r_{R}). Here, the gains (g) output from channels may be expressed as in equation 3 below and the phase difference (Δ) between the channels may be expressed as in equation 4 below:

$$\begin{matrix}Equation 3 \text{:} & \\ g = \frac{{r}_{L}}{{r}_{R}} & \end{matrix}$$

Equation 4:

Δ=|int(F_{S}(r_{L}−r_{R})/|c)|

In equation 4, for example, c is the velocity of sound. The gain (g) information and phase difference (Δ) information calculated according to equations 3 and 4 may be provided to the audio signal processing unit 445, which will be explained in greater detail herein below. Here, the gain (g) according to equation 3 may be used to adjust the magnitude, i.e., volume, of audio in each channel output through the audio output unit 447. Also, the phase difference (Δ) according to equation 4 is used to determine how much time delay to be given to the audio in each channel before the audio in each channel is output through the audio output unit 447.

Referring again to FIG. 4, the signal processing unit 451 may process at least one of a decoded image signal, a decoded audio signal, and additional data, for example. To achieve this, the signal processing unit 451 may be composed of an audio signal processing unit 445 and an image signal processing unit 495, for example.

The audio signal processing unit 445 may correct audio to be output through the first speaker 41 and the second speaker 42, respectively, based on the gain (g) information and the phase difference (Δ) information provided by the calculation unit 495. As an example, in the case where the pointed-to spot is close to the first speaker 41 as illustrated in FIG. 7, the audio signal processing unit 445 may correct audio to be output through the first speaker 41 as in equation 5 below, while audio to be output through the second speaker 42 is represented as in equation 6 below:

Equation 5:

y_{L}=gx_{L}(n−Δ)

Equation 6:

y_{R}=x_{R}(n)

In equation 5, assuming that xL is audio currently output through the first speaker 41 and n is the phase of the audio currently output through the first speaker 41, it can be seen that the volume of the audio (yL) to be output through the first speaker 41 may be increased by a factor of the gain (g) compared to the volume of the audio (xL) currently output through the first speaker 41. Also, it can be seen that the phase of the audio (yL) to be output through the first speaker 41 is diminished by the phase difference (Δ) compared to the phase (n) of the audio (xL) currently output through the first speaker 41.

Likewise, in equation 6, assuming that x_{R} is audio currently output through the second speaker 42 and n is the phase of the audio currently output through the second speaker 42, it can be seen that the volume and phase of the audio (y_{R}) to be output through the second speaker 42 are identical to those of the audio (x_{R}) currently output through the second speaker 42.

As another example, the audio signal processing unit 445 may correct audio to be output through the first speaker 41 as in equation 7 below and correct audio to be output through the second speaker 42 as in equation 8 below.

Equation 7:

y_{L}=gx_{L}(n)

Equation 8:

y_{R}=x_{R}(n+Δ)

That is, while maintaining the phase of the audio (y_{L}) to be output to the first speaker 41 the same as the phase (n) of the audio currently output through the first speaker 41, the audio signal processing unit 445 may increase only the volume of the audio (y_{L}) to be output through the first speaker 41 by a factor of the gain (g). Also, while maintaining the volume of the audio (y_{R}) to be output to the second speaker 42 the same as the volume of the audio (x_{R}) currently output to the second speaker 42, the audio signal processing unit 445 may increase only the phase by the phase difference (Δ).

Audio corrected in each channel by the audio signal processing unit 445 according to the method described above may be output through speakers corresponding to the respective channels.

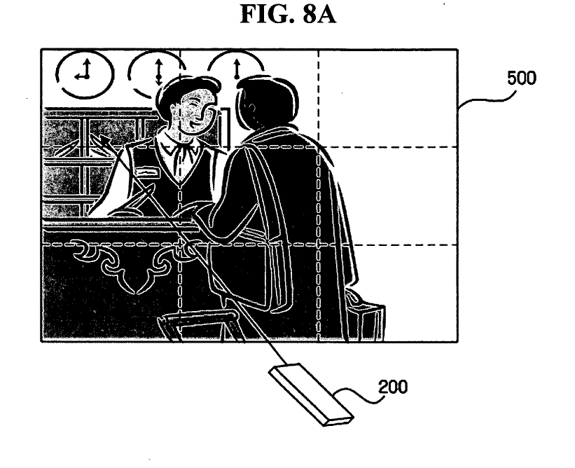

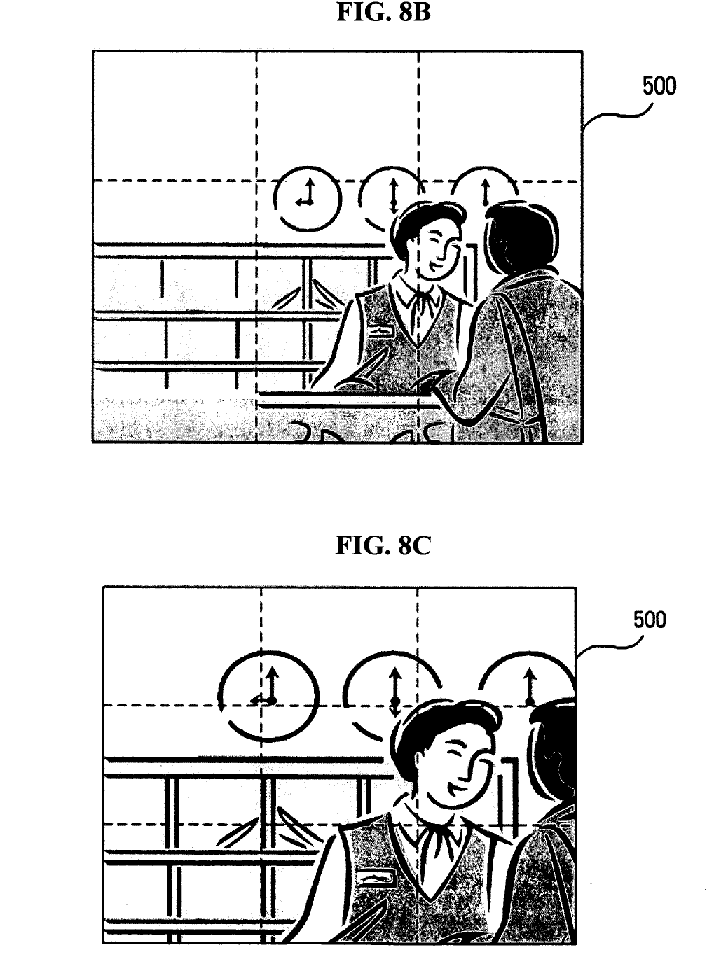

Meanwhile, the image signal processing unit 455 may correct a position at which an image provided by the video decoder 450 is displayed, based on the distance value provided by the calculation unit 495. More specifically, the image signal processing unit 455 may correct the position at which the image is displayed so that the center of the subregion including the pointed-to spot matches with the center of the display region 500. For example, if a spot pointed to by the user is included in a first subregion 510 as illustrated in FIG. 8A, the image signal processing unit 455 corrects the position at which the image is displayed, so that the central point of the first subregion 510 matches with the central point of the display region 500, as illustrated in FIG. 8B.

The image signal processing unit 455 may correct the scale of the image with respect to the subregion including the pointed-to spot. For example, the image may be enlarged with respect to the subregion including the pointed-to spot as illustrated in FIG. 8C. Here, the same image enlargement ratio may be applied to all subregions or a different image enlargement ratio may be applied to each subregion. More specifically, referring to FIG. 5, images including objects closest to the user are usually displayed in the seventh through ninth subregions 570 through 590 in the image displayed through the display region 500. Meanwhile, images including objects relatively distant from the user are usually displayed in the first through third subregions 510 through 530. Here, a bigger enlargement ratio may be applied to a subregion positioned on the top. For example, the enlargement ratio may be set to 1 for the seventh through ninth subregions 570 through 590, to 1.5 for the fourth through sixth subregions 540 through 560, and to 2 for the first through third subregions 510 through 530, although different enlargement ratios may be used. In this way, the enlargement ratio information for each subregion may be stored in the mapping table 600 described above.

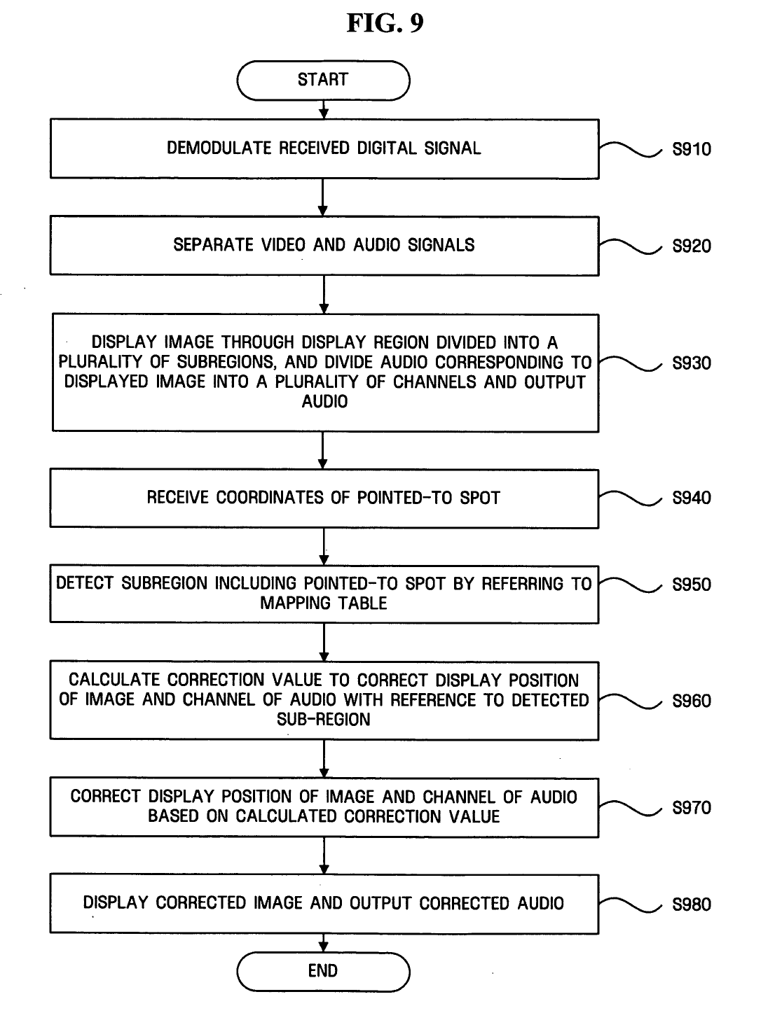

Next, referring to FIGS. 8A through 9, a method of reproducing multimedia content, according to an embodiment of the present invention will now be explained. FIG. 9 illustrates a method of reproducing multimedia content, according to an embodiment of the present invention.

First, if the user selects a predetermined channel, the tuner 410 of the system for reproducing multimedia content may tune the reception band of the channel selected by the user. Then, the tuner 410 may transform the received signal wave into an intermediate frequency signal and provide the signal to the demodulation unit 420.

The demodulation unit 420 may demodulate the digital signal provided from the tuner 410 and provide data in the MPEG-2 transport stream format, for example, to the demultiplexing unit 430 in operation S910.

The demultiplexing unit 430 may separate compressed audio data and compressed image data from the input MPEG-2 transport stream and provide the audio data and image data to the audio decoder 440 and the video decoder 460, respectively, in operation S920.

The audio decoder 440 may decode the audio data provided from the demultiplexing unit 430 and provide the decoded audio data to the audio signal processing unit 445. The audio signal processing unit 445 may perform predetermined signal processing on the audio data provided from the audio decoder 440 and output audio through the audio output unit 447 in operation S930.

Meanwhile, the video decoder 450 may decode the image data provided from the demultiplexing unit 430 and provide the decoded image data to the image signal processing unit 455. The image signal processing unit 455 may display the image data provided from the video decoder 450 through the display unit 457 in operation S930.

While the image is displayed through the display unit 457 in this way, if a predetermined spot is pointed to by the user as illustrated in FIG. 8A, the direct pointing device 200 may detect the position in the display region 500 of the system 400 at which the spot pointed to by the user is located. That is, the coordinates detection unit 220 may calculate the coordinates of the pointed-to spot in the detected display region 500. Here, the coordinates detection unit 220 may detect the coordinates of the pointed-to spot according to the method described above with reference to FIGS. 3A through 3C.

The detected coordinates of the pointed-to spot may be transformed into a predetermined wireless signal, for example, an infrared signal, which may be transmitted to the system for reproducing multimedia content 400.

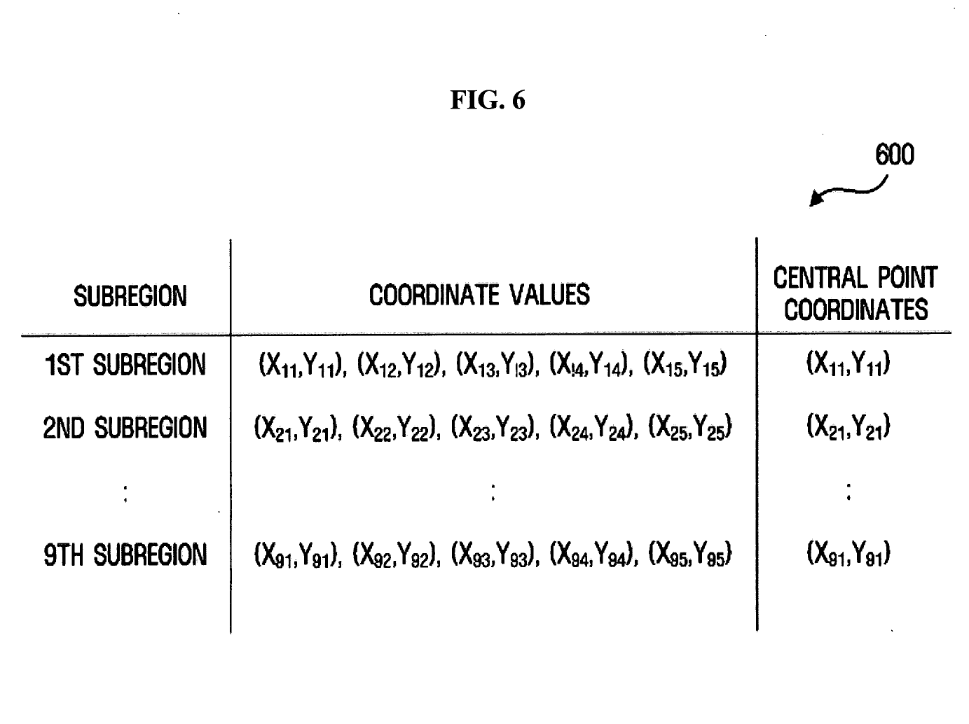

Meanwhile, the reception unit 470 of the system 400 may receive the signal containing the coordinates of the pointed-to spot from the direct pointing device in operation S940. Then, the region detection unit 490 may detect a subregion including the pointed-to spot, by referring to the mapping table 600 stored in the storage unit 480 in operation S950. For example, if the mapping table 600 is as illustrated in FIG. 6 and the coordinates of the pointed-to spot are (X₁, Y₁), the region detection unit 490 may detect that the first subregion 510 is the subregion including the pointed-to spot in operation S950. Information on the detected first subregion 510, that is, information on the coordinates of the central point of the first subregion 510, may be provided to the calculation unit 495.

Based on the information on the detected first subregion 510, the calculation unit 495 may calculate correction values to correct the scale of an image, and the audio channel, respectively, in operation S960.

More specifically, the calculation unit 495 may calculate a correction value to correct the scale of the image with respect to the first subregion 510. In other words, the calculation unit 495 may calculate the distance between the center of the first subregion 510 and the center of the display region 500, for example.

Then, the calculation unit 495 may calculate a correction value to correct the audio channel output through the audio output unit 447. In other words, the calculation unit 495 may calculate the gain output from, and the phase difference between, channels output through the audio output unit 447. To achieve this, the calculation unit 447 may position a virtual user at a position facing the pointed-to spot as illustrated in FIG. 7.

Then, the calculation unit 495 may calculate the angle (θ) between the line segment connecting the pointed-to spot and the virtual user and the line segment connecting the virtual user and the central point of the display region 500, by referring to an already stored database.

Next, the calculation unit 495 may calculate the distance r_{L} between the virtual user and the first speaker 41 and the distance r_{R} between the virtual user and the second speaker 42, based on the calculated angle (θ), the distance (d) between the central point of the display region 500 and the first speaker 41, and the distance information r between the central point and the virtual user, for example.

The distance r_{L} between the virtual user and the first speaker 41 may be calculated according to equation 1 as described above, and the distance r_{R} between the virtual user and the second speaker 42 may be calculated according to equation 2 as described above.

If the distance r_{L} between the virtual user and the first speaker 41 and the distance r_{R} between the virtual user and the second speaker 42 are calculated according to equations 1 and 2, respectively, the calculation unit 495 may calculate the gain (g) output from each of the channels and the phase difference (Δ) between the channels output through each speaker, based on the calculated distance values (r_{L} and r_{R}).

The gain (g) output from each of channels may be calculated according to equation 3 as described above and the phase difference (Δ) between the channels may be calculated according to equation 4 as described above.

If the correction values are calculated in this way, the image signal processing unit 455 and the audio signal processing unit 445 may correct the position at which the image is displayed, and one of a plurality of audio channels output through the audio output unit 447, respectively, based on the calculated correction values in operation S970.

First, the image signal processing unit 455 may correct the position at which the image provided from the video decoder 450 is displayed, based on the distance information between the pointed-to spot and the central point of the display region 500 included in the correction values calculated by the calculation unit 495. For example, the image signal processing unit 455 may correct the position at which the image is displayed, so that the center of the first subregion 510 matches with the center of the display region 500 as illustrated in FIG. 8B, in operation S970. The image signal processing unit 455 may also correct the scale of the image with respect to the first subregion 510. For example, the image may be enlarged with respect to the first subregion as illustrated in FIG. 8C. Here, the same image enlargement ratio may be applied to all subregions or a different enlargement ratio may be applied to each subregion, according to the positions of the subregions. For example, a bigger enlargement ratio may be applied to a subregion positioned at the top of the display region 500. The image corrected by the image signal processing unit 455 in this way may be displayed through the display unit 457 in operation S980.

Meanwhile, the audio signal processing unit 445 may correct one of a plurality of audio channels based on the gain (g) and phase difference (Δ) in the correction values calculated by the calculation unit 495. For example, the audio signal processing unit 445 may correct audio output through the first speaker 41 according to equation 5, and correct audio output through the second speaker 42 according to equation 6. As another example, the audio signal processing unit 445 may also correct the audio output through the first speaker 41 according to equation 7 and the audio output through the second speaker 42 according to equation 8. The channels corrected by the audio signal processing unit 445 in this way may be output through the speakers corresponding to respective channels in operation S980.

The system reproducing multimedia content 400 is described above with the example in which the display region 500 is pointed to by the predetermined pointing unit. However, the present invention may be applied to a system having no separate pointing apparatus. For example, a subregion that the user wants to watch attentively may be detected by sensing the eyes or audio of the user.

The present invention has been described herein above with reference to flowchart illustrations of a system and method for reproducing multimedia content according to one or more embodiments. It will be understood that each block of the flowchart illustrations, and combinations of blocks in the flowchart illustrations, may be implemented by computer readable code/instructions in/on a medium, e.g., a computer readable medium, to control at least one processing element to implement any above described embodiment. The computer readable code may be provided to a processor of a general purpose computer, special purpose computer, or other programmable data processing system to implement the functions specified in the flowchart block or blocks.

The computer readable code may also be stored in a computer usable or computer-readable memory that may direct a computer or other programmable data processing system to function in a particular manner, such that the instructions implement the function specified in the flowchart block or blocks.

The computer readable code may also be loaded onto a computer or other programmable data processing system to cause a series of operations to be performed on the computer or other programmable system to produce a computer implemented process for implementing the functions specified in the flowchart block or blocks.

The computer readable code may be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to one or more embodiments of the present invention. The media may also be a distributed network, so that the computer readable code is stored/transferred and executed in a distributed fashion. Still further, as only an example, the processing element may include a processor or a computer processor, and processing elements may be distributed and/or included in a single device.

In addition, each block may represent a module, a segment, or a portion of code, which may comprise one or more executable instructions for implementing the specified logical functions. It should also be noted that in other implementations, the functions noted in the blocks may occur out of the order noted or in different configurations of hardware and software.

According to the system, method and medium of reproducing multimedia content of the present invention as described above, when multimedia content is enjoyed, the image and audio are corrected with respect to a region in which the user is interested, and in this way the user experiences an ambience effect.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A system reproducing multimedia content, the system comprising:
a display unit to display an image through a display region divided into a plurality of subregions;
an audio output unit to divide audio corresponding to the displayed image into a plurality of channels and to output the audio;
a calculation unit to calculate correction values to correct a display position of the image and to correct the audio channels corresponding to a subregion selected by a user; and
a signal processing unit to correct the display position and the audio channels based on the calculated correction values.

2. The system of claim 1, wherein the signal processing unit enlarges a portion of the image corresponding to the selected subregion.

3. The system of claim 1, wherein the signal processing unit moves an image of the selected subregion to a center of the display region.

4. The system of claim 1, wherein the correction value for the image is the distance between a center of the selected subregion and a center of the display region.

5. The system of claim 1, wherein the correction value for the audio comprises a gain output from each of the audio channels and a phase difference between the audio channels output from the audio output unit.

6. The system of claim 1, further comprising a reception unit to receive coordinates of a pointed-to spot in the displayed image from the user, and a region detecting unit to detect a sub-region from the plurality of sub-regions corresponding to the pointed-to spot.

7. A method reproducing multimedia content, the method comprising:
displaying an image through a display region divided into a plurality of subregions;
dividing audio corresponding to the displayed image into a plurality of channels and outputting the audio;
calculating correction values to correct a display position of the image, and to correct the audio channels corresponding to a subregion selected by a user; and
correcting the display position and the audio channels based on the calculated correction values.

8. The method of claim 7, wherein the correcting of the display position and the audio channels comprises enlarging a portion of the image corresponding to the selected subregion.

9. The method of claim 7, wherein in the correcting of the position and the channel, an image of the selected subregion is moved to a center of the display region.

10. The method of claim 7, wherein the correction value for the image is the distance between a center of the selected subregion and a center of the display region.

11. The method of claim 7, wherein the correction value for the audio comprises a gain output from each of the audio channels and a phase difference between the audio channels.

12. The method of claim 7, further comprising receiving coordinates of a pointed-to spot in the displayed image from the user, and detecting a sub-region from the plurality of sub-regions corresponding to the pointed-to spot.

13. At least one medium comprising computer readable code to control at least one processing element to implement a method reproducing multimedia content, the method comprising:
displaying an image through a display region divided into a plurality of subregions;
dividing audio corresponding to the displayed image into a plurality of channels and outputting the audio;
calculating correction values to correct a display position of the image, and to correct the audio channels corresponding to a subregion selected by a user; and
correcting the display position and the audio channels based on the calculated correction values.

14. The medium of claim 13, wherein the correcting of the display position and the channel comprises enlarging a portion of the image corresponding to the selected subregion.

15. The medium of claim 13, wherein in the correcting of the position and the audio channels, an image of the selected subregion is moved to a center of the display region.

16. The medium of claim 13, wherein the correction value for the image is the distance between a center of the selected subregion and a center of the display region.

17. The medium of claim 13, wherein the correction value for the audio comprises a gain output from each of the audio channels and a phase difference between the audio channels.

18. The medium of claim 13, further comprising receiving coordinates of a pointed-to spot in the displayed image from the user, and detecting a sub-region from the plurality of sub-regions corresponding to the pointed-to spot.
